(19) United States
(12) Patent Application Publication
(10) Pub. No.: US 2008/0196574 A1
(43) Pub. Date: Aug. 21, 2008

(54) ADJUSTABLE DRUM PEDAL AND METHOD THEREFOR

(76) Inventor: Goran Kjellgren, Flagstaff, AZ (US)

Correspondence Address: WEISS & MOY PC, 4204 NORTH BROWN AVENUE, SCOTTSDALE, AZ, 85251, US

(21) Appl. No.: 12/109,205

(22) Filed: Apr. 24, 2008

Related U.S. Application Data
(63) Continuation-in-part of application No. 11/203,455, filed on Aug. 12, 2005.

(51) Int. Cl. G10D 13/02

(52) U.S. Cl. 84/422.1

(57) ABSTRACT

An adjustable drum pedal has a foot pedal and a base plate. A frame is coupled to the base plate. A support bar having a slot running a length of the support bar is coupled to the frame and raised above the base plate. A drum beater mechanism is movably coupled to the frame to allow one to adjust a position of the drum beater mechanism on the frame. A drive assembly is movably coupled to the drum beater mechanism and the foot pedal for moving the drum beater mechanism when pressure is applied to the foot pedal and for returning the drum beater mechanism to a starting position when pressure is removed from the foot pedal. A clamping device is movably coupled to the base plate for allowing one to couple the adjustable drum pedal in multiple positions relative to a drum. An adjustment device has a first end coupled to the foot pedal and a second end slidably coupled in the slot in the support bar. The adjustment device is used for adjusting a position of the foot pedal relative to the base plate.

### RELATED APPLICATIONS

The present application is a Continuation-In-Part of U.S. patent application entitled “ADJUSTABLE DRUM PEDAL AND METHOD THEREFOR”, having Ser. No. 11/203,455, filed on Aug. 12, 2005 and which is related to U.S. Pat. No. 6,570,076, entitled “ADJUSTABLE DRUM PEDAL AND METHOD THEREFOR” having Ser. No. 09/992,868, filed Nov. 16, 2001. The above are both in the name of the same inventor and are hereby incorporated herewith.

### FIELD OF THE INVENTION

This invention generally to musical instruments and more specifically, to an adjustable drum pedal which allows the user to adjust the position and/or angel of the pedal in order to have better control and comfort when using the drum pedal.

### BACKGROUND OF THE INVENTION

In order to operate a bass drum, a pedal mechanism is generally provided which includes a depressible foot pedal. When the foot pedal is depressed, a means is activated which causes a beater ball to move through an arc and strike the bass drum. When pressure is removed from the pedal and the pedal is released, the beater ball will return to a resting position ready to move forward again to strike the drum when pressure is again applied to the foot pedal and depressed again.

It is a well known that the feet of different people are different in both size and shape. Furthermore, many people have alignment problems with their feet such as being pigeon toed or duck footed. Other individuals have feet which may be diseased or have a muscle control problem. However, present conventional bass drum pedal are not adjustable in order to compensate for the above mentioned problems. Present bass drum pedals have no mechanism in which to allow the operator to adjust the position of the foot pedal in different directions in a quick and efficient manner as well as to adjust the position of the beater ball.

Therefore, a need existed to provide an adjustable drum pedal that overcomes the above mentioned problem. The adjustable drum pedal will allow the operator to adjust the position of the foot pedal in different directions in a quick and efficient manner. The adjustable drum pedal will further allow the operator to adjust the position of the beater ball.

### SUMMARY OF THE INVENTION

In accordance with one embodiment of the present invention, an adjustable drum pedal has a foot pedal and a base plate. A frame is coupled to the base plate. A support bar having a slot running a length of the support bar is coupled to the frame and raised above the base plate. A drum beater mechanism is movably coupled to the frame to allow one to adjust a position of the drum beater mechanism on the frame. A drive assembly is movably coupled to the drum beater mechanism and the foot pedal for moving the drum beater mechanism when pressure is applied to the foot pedal and for returning the drum beater mechanism to a starting position when pressure is removed from the foot pedal. A clamping device is movably coupled to the base plate for allowing one to couple the adjustable drum pedal in multiple positions relative to a drum. An adjustment device has a first end coupled to the foot pedal and a second end slidably coupled in the slot in the support bar. The adjustment device is used for adjusting a position of the foot pedal relative to the base plate

The present invention is best understood by reference to the following detailed description when read in conjunction with the accompanying drawings.

### BRIEF DESCRIPTION OF THE DRAWINGS

FIG. 1 is an elevated perspective view of one embodiment of the adjustable drum pedal of the present invention.

FIG. 2 is a partial bottom view of the rear section of the base plate used in the adjustable drum pedal depicted in FIG. 1.

FIG. 3 is a cross sectional side view of the adjustable drum pedal taken along lines 3-3 of FIG. 2.

FIG. 4 is a side view of the adjustable drum clamp used in the adjustable drum pedal of FIG. 1.

FIG. 5 is a partial front view of the cam and beater mechanism of the adjustable drum pedal of FIG. 1.

FIG. 6 is a cross sectional side view of the cam mechanism used in the adjustable drum pedal taken along lines 6-6 of FIG. 5.

FIG. 7 is a cross sectional side view of the beater mechanism used in the adjustable drum pedal taken along lines 7-7 of FIG. 5.

FIG. 8 is a partial bottom view of the top section of the base plate used in the adjustable drum pedal depicted in FIG. 1.

FIG. 9 is a cross sectional side view of the support bars used in the adjustable drum pedal depicted in FIG. 1.

FIG. 10 is a cross section view of the spring mechanism used in the adjustable drum pedal taken along lines 10-10 of FIG. 5.

FIG. 11 is an elevated perspective view of another embodiment of the adjustable drum pedal of the present invention.

FIG. 12 is an elevated perspective view of the embodiment of FIG. 11 with a section of the pedal removed.

FIG. 13 is a top view of the embodiment of FIG. 11.

Common reference numerals are used throughout the drawings and detailed description to indicate like elements.

### DETAILED DESCRIPTION

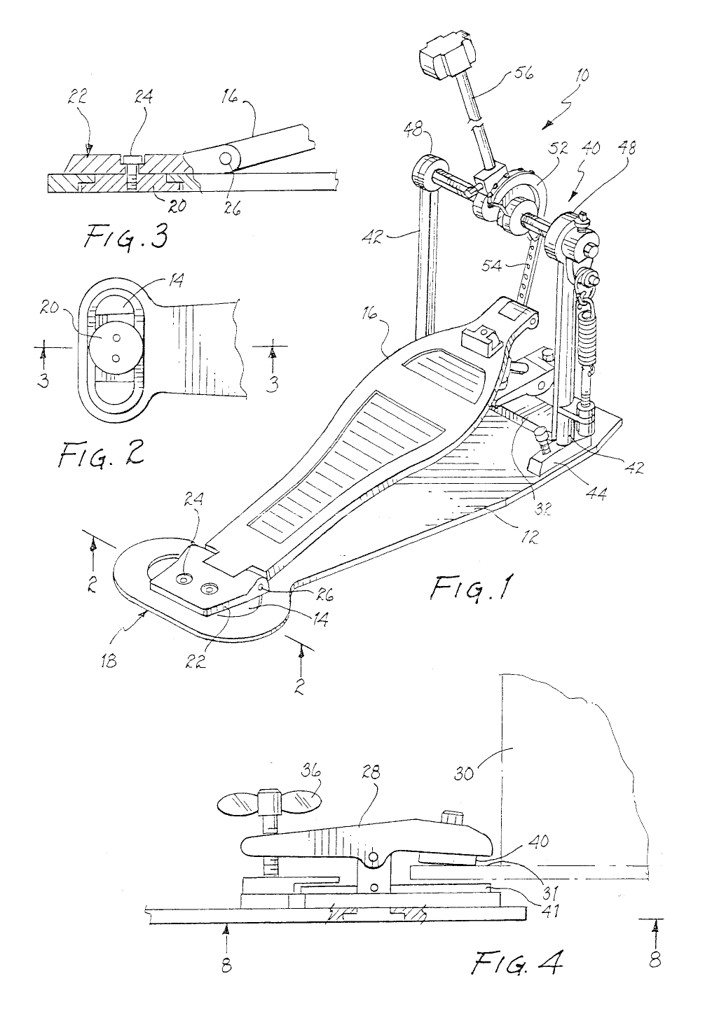

Referring now to the FIG. 1, an adjustable drum pedal 10 (hereinafter drum pedal 10) is shown. The drum pedal 10 has a base plate 12. The base plate 12 has a first slot 14 located along a bottom section of the base plate 12. The slot 14 runs along the majority of the width of the base plate 12. A foot pedal 16 is movably coupled to the base plate 12 within the first slot 14. A coupling mechanism 18 is used to movably coupled the foot pedal 16 to the base plate 12 and to allow the foot pedal 16 to pivot in a vertical manner.

Referring now to FIG. 2 wherein like numerals and symbols represent like elements, a magnified view of the coupling mechanism 18 is shown. The coupling mechanism 18 has a tab member 20. The tab member 20 is of a size to secure the foot pedal 16 within the first slot 14. The tab member 20 will allow the foot pedal 16 to slide within the first slot 14. The tab member 20 will further allow the foot pedal 16 to rotate about the tab member. Thus, the tab member 20 will allow the operator of the drum pedal 10 to quickly and easily adjust the position of the foot pedal 16 relative to the base plate 12. The operator will then be able to comfortably place his/her foot completely on the foot pedal 16 no matter what size, shape or alignment problem he/she may have.

The coupling mechanism 18 further has a hinged member 22. In the embodiment depicted in FIG. 3, the hinged member 22 is coupled to the tab member 20. However, it should be noted that the tab member 20 and the hinged member 22 may be formed of a single piece. In the present embodiment, the hinged member 22 is coupled to the tab member 20 via one or more connectors 24. The foot pedal 16 is coupled to the hinged member 22 by a pin 26. The pin 26 allows the foot pedal 16 to pivot about the hinged member 22.

Referring now to FIG. 4 wherein like numerals and symbols represent like elements, a clamping device 28 is shown. The clamping device 28 is used to attach the drum pedal 10 to a rim of a bass drum 30. What is unique about the clamping device 28 is that the clamping device 28 is adjustable. The clamping device 28 will allow the operator to adjust the position of the drum pedal 10 in relation to the bass drum 30.

The base plate 12 has a second slot 32 (See also FIG. 8). The second slot 32 is located on a top section of the base plate 12. The second slot runs a majority of the width of the base plate 12. The clamping device 28 is designed so that the clamping device 28 is allowed to slide within the second slot 32 in order to adjust the position of the clamping device 28. The clamping device 28 will have a tab member 34. The tab member 34 is of a sufficient size to secure the clamping device 28 within the second slot 32 but still allow the clamping device 28 to slide within the second slot 32.

The clamping device 28 has an adjustment device 36. The adjustment device 36 is used to lock the clamping device 28 in position. By loosening the adjustment device 36, the operator may slide the clamping device 28 within the second slot 32 in order to adjust the position of the clamping device 28. When the operator has selected the proper position for the base pedal 10, the operator will tighten the adjustment device 36 to lock the clamping device 28 in position. By tightening the clamping device 28, the operator will further secure the foot pedal 10 to the rim 31 of the bass drum 30. By tightening the adjustment device 36, a pair of skid resistant pads 40 will contract around the rim 31 of the bass drum 30 securing the foot pedal 10 to the bass drum 30. The clamping device 28 has a follower rod 41. The follower rod 41 will help in locking the clamping device 28 to the bottom of the rim 31 of the bass drum 30. The follower rod 41 will have a skid resistant pad 40 to aid in securing the foot pedal 10 to the bass drum 30.

Referring now to FIGS. 1 and 5, a beater support bar 40 is coupled to the base plate 12. The beater support bar 40 is comprised of a pair of vertical bar members 42. As seen more clearly in FIG. 9, one end of each vertical bar member 42 is coupled to a base member 44. The base member 44 is coupled to the base plate 12 via a coupling device 46. The coupling device 46 may be a screw, peg, rivet, or similar item. It should be noted that the above listing should not be seen as to limit the scope of the present invention.

On the other end of each vertical bar members 42 is a loop member 48. A crossbar 50 is inserted into each of the loop members 48. The crossbar 50 is allowed to rotate within the loop members 48 when a torque is applied to the crossbar 50. A wheel mechanism 52 is coupled to the crossbar 50. The wheel mechanism 52 is further coupled to the foot pedal 16 via a belt 54. The belt 54 may be a metal chain, a rubber belt or like element. It should be noted that the listing of the above examples should not be seen as to limit the scope of the present invention. When pressure is applied to the foot pedal 16, the belt 54 (via the wheel mechanism 52) will cause the crossbar 50 to rotate. This will cause a drum beater 56, which is also coupled to the crossbar 50, to strike the bass drum 30.

The wheel mechanism 52 has a release mechanism 53. The release mechanism 53 will allow the wheel mechanism 52 to slide on the crossbar 50 and be placed at any position on the crossbar 50. This will increase the adjustability of the drum pedal 10. This is due to the fact that moving the wheel mechanism 52 will allow the foot pedal 16 to move and pivot to a greater degree.

Referring now specifically to FIG. 7, as stated above, the drum beater 56 is also coupled to the crossbar 50. What is unique about the drum beater 56 is that the drum beater 56 is removably coupled to the cross bar 50. The drum beater 56 has a release mechanism 58. The release mechanism 58 will allow the drum beater 56 to slide along the crossbar 50 and to be placed at any position on the crossbar 50. This will allow the drum beater 56 to always be striking the center of the bass drum 30 no matter the position of the drum pedal 10. Furthermore, by moving the drum beater 56, one may increase the adjustability of the drum pedal 10. This is due to the fact that moving the drum beater 56 will allow the foot pedal 16 to move and pivot to a greater degree.

Referring now to FIGS. 1, 5, and 7, a spring device 60 is coupled to the crossbar 50. The spring device 60 has a cam 62. The cam 62 is coupled to the crossbar 50. One end of a spring 64 is coupled to the cam 62. The other end of the spring 64 is coupled to the base plate 12 or the base member 44. When pressure is applied to the foot pedal 16, the crossbar 50 will rotate causing the drum beater 56 to strike the bass drum. When pressure is removed from the foot pedal 16, the spring device 60 will bring the crossbar 50 back to its original position drawing the drum beater 50 back away from the bass drum 30.

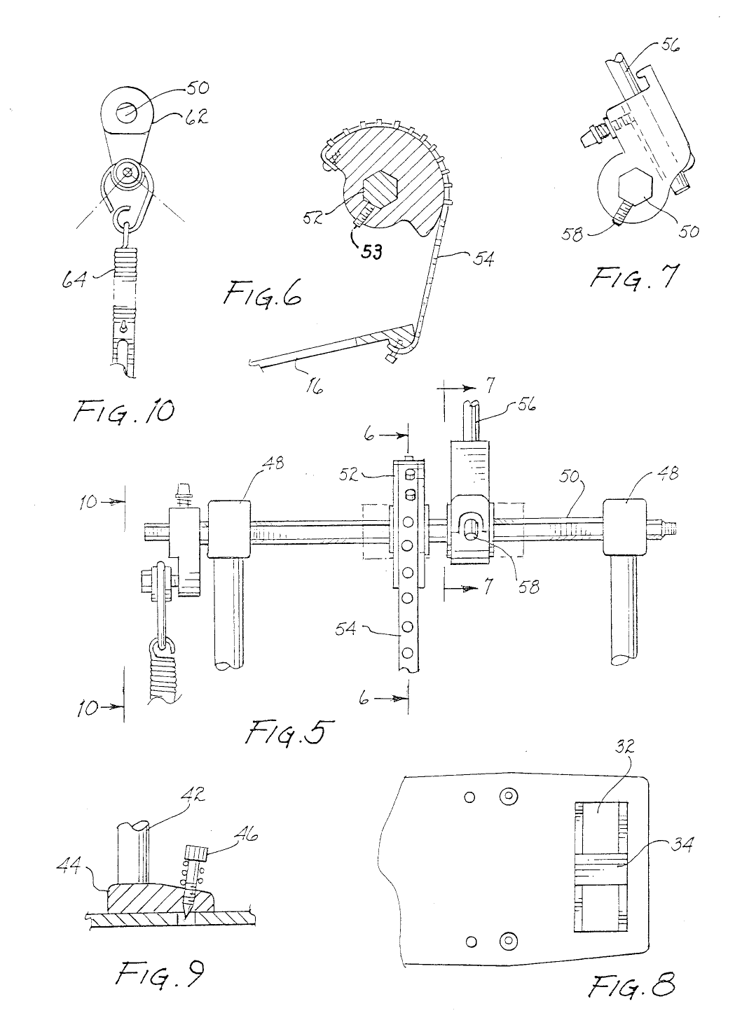

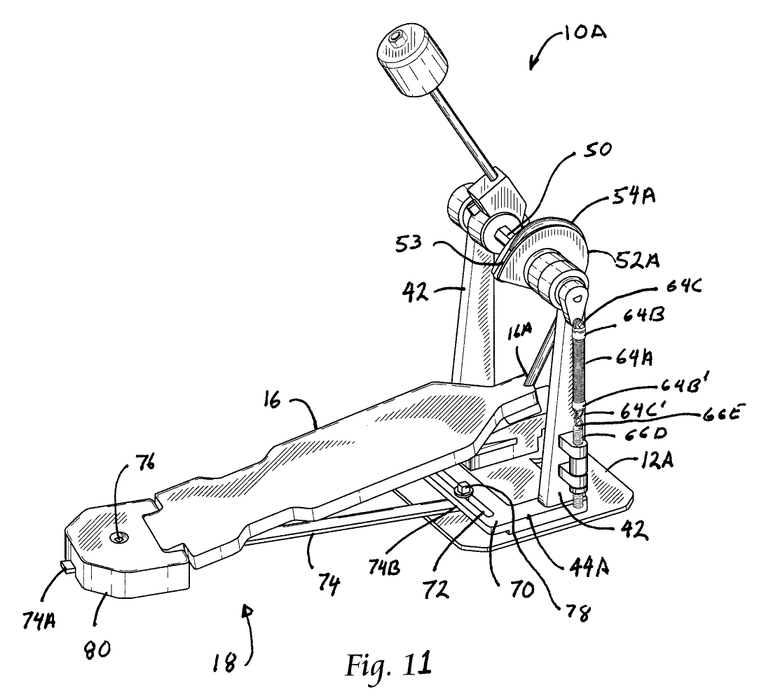

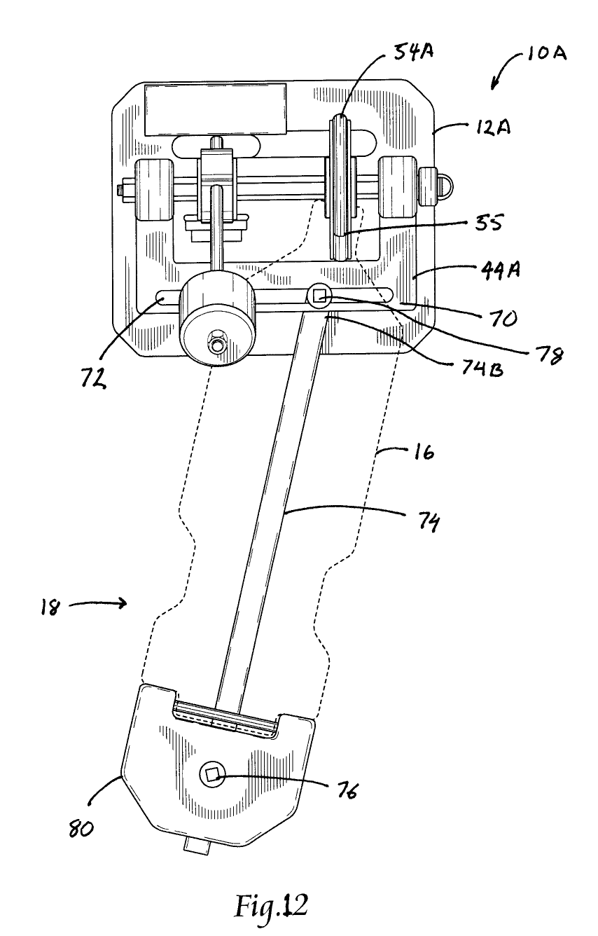

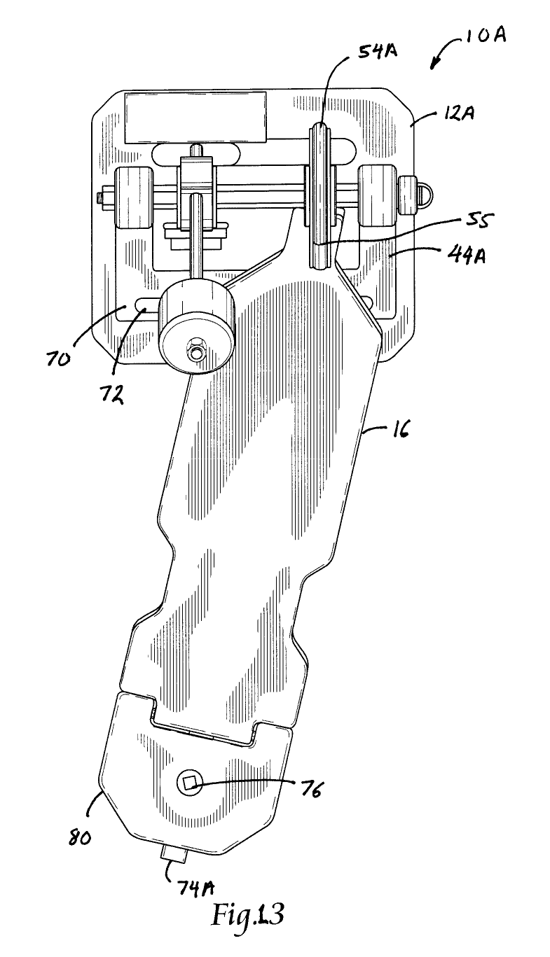

Referring to FIGS. 11-13, wherein like numerals and symbols represent like elements, another embodiment of the present invention is show. In this embodiment, the drum pedal 10A is basically the same as that shown in FIGS. 1-10. Thus, only the differences will be elaborated upon.

In this embodiment, the full length base plate 12 has been replaced with a base plate 12A that runs approximately a third of the length of the foot pedal 16. The base member 44A has further been changed to have a support bar 70 coupled horizontally between the vertical bar members 42. The support bar 70 is coupled to the vertical bar members 42 so as to be slightly raised above the base plate 12A. The support bar 70 will have a slot 72 which runs a majority of the length of the support bar 70 in a horizontal manner.

The coupling mechanism 18 is still used to movably couple the foot pedal 16 to the base plate 12A and to allow the foot pedal 16 to pivot in a vertical manner. In the embodiment depicted in FIGS. 11-13, the coupling mechanism 18 has a foot pedal tab 80. A bottom surface of the foot pedal tab 80 will be approximately planar with a bottom surface of the base plate 12A. A non skid type of material may be placed on the bottom surface of the foot pedal tab 80 to prevent the foot pedal tab 80 from moving when the drum pedal 10A is being used. The foot pedal tab 80 is hingly coupled to the foot pedal 16A to allow the foot pedal 16A to pivot in an up and down motion. A bar member 74 has a first end 74A which is secured to the foot pedal tab 80 using an attachment device 76. The attachment device 76 may be a screw, peg, rivet, or the like. The second end 74B of the bar member 74 is slidable coupled to the support bar 70. The second end 74B is coupled to the slot 72 in the support bar 70 using a coupling device 78. The second end 74B is coupled to the slot 72 in the support bar 70 to allow the second end 74B of the bar member to slide in the slot 72. The coupling device 78 may be a screw, peg, rivet, or similar item. It should be noted that the above listing should not be seen as to limit the scope of the present invention.

The bar member 74 will allow the foot pedal 16 to slide within the slot 72. Thus, the bar member 74 will allow the operator of the drum pedal 10A to quickly and easily adjust the position of the foot pedal 16 relative to the base plate 12A. The operator will then be able to comfortably place his/her foot completely on the foot pedal 16 no matter what size, shape or alignment problem he/she may have.

In FIG. 11-13, the belt 54 used with the wheel mechanism 52A is cord/rope 54A. The cord/rope 54A uses a pair of end caps 55. The end caps 55 are used to couple the cord/rode 54A to the wheel mechanism 52A and the foot pedal 16. One end cap 55 is used to secure the cord/rope 54A to the wheel mechanism 52A. A channel 53 is formed in the wheel mechanism 52A to hold the cord/rope 54A in the wheel mechanism 52A. Once the cord/rope 54A is placed in the channel 53, an end cap 55 is placed around the cord/rode 54A and inserted into the end 53A of the channel 53. The other end of the cord/rope 54A is coupled to the foot pedal 16. A channel 16A is formed in a front bottom section 16B of the foot pedal 16. The cord/rope 54A is placed in the channel 16A. The second end cap 55 is placed on the cord/rope 54A to secure the cord/rope 54A in the foot pedal 16. The use of the cord/rope 54A decreases the cost of the drum pedal 10 and is easier to change out than the belt 54. The use of the channel 53 and the channel 16A along with the end cap, assure that the cord/rope 54A stays properly mounted.

The spring device 64A has also been modified. The spring device 64A has a first end cap 64B. A ring 64C is coupled to the end cap 64B. The ring 64C is then mounted to the crossbar 50. The other end of the spring 64A has a second end cap 64B′ with a ring 64C′ coupled thereto. The ring 64C′ is hingly coupled to a bar member 66D via pin 66E. The bar member 66D being coupled to a bottom section of the vertical bar members 42. When pressure is applied to the foot pedal 16, the crossbar 50 will rotate causing the drum beater 56 to strike the bass drum. When pressure is removed from the foot pedal 16, the spring device 60 will bring the crossbar 50 back to its original position drawing the drum beater 50 back away from the bass drum 30. The use of the end caps 64B and 64B′, the rings 64C and 64C′, and the pin 66E help in rotating the spring 64A when the foot pedal 16 is pressed. The rotation of the spring 64A allows for a smoother movement of the foot pedal 16 when it is pressed downward and when it returns to its original resting position.

This disclosure provides exemplary embodiments of the present invention. The scope of the present invention is not limited by these exemplary embodiments. Numerous variations, whether explicitly provided for by the specification or implied by the specification, such as variations in structure, dimension, type of material and manufacturing process may be implemented by one skilled in the art in view of this disclosure.

What is claimed is:

1. An adjustable drum pedal comprising, in combination:
a foot pedal;
a base plate;
a frame coupled to the base plate;
a support bar having a slot running a length of the support bar coupled to the frame and raised above the base plate;
a drum beater mechanism movably coupled to the frame to allow one to adjust a position of the drum beater mechanism on the frame;
a drive assembly movably coupled to the drum beater mechanism and the foot pedal for moving the drum beater mechanism when pressure is applied to the foot pedal and for returning the drum beater mechanism to a starting position when pressure is removed from the foot pedal;
a clamping device movably coupled to the base plate for allowing one to couple the adjustable drum pedal in multiple positions relative to a drum; and
an adjustment device having a first end coupled to the foot pedal and a second end slidably coupled in the slot in the support bar for adjusting a position of the foot pedal relative to the base plate.

2. An adjustable drum pedal in accordance with claim 1 wherein the adjustment device comprises:
a foot pedal tab hingly coupled to the foot pedal for allowing the foot pedal to pivot in an up and down motion; and
a bar member having a first end coupled to the foot pedal tab and a second end slidably coupled in the slot in the support bar.

3. An adjustable drum pedal in accordance with claim 1 further comprising:
a second slot running along a width of a top section of the base plate; and
a clamping device adjustment mechanism position in the second slot and coupled to the clamping device for allowing the clamping device to move within the second slot.

4. An adjustable drum pedal in accordance with claim 1 wherein the frame comprises:
a pair of support bars;
base members coupled to the base plate and the pair of support bars for coupling the support bars to the base plat; and
a cross bar rotatably coupled to the support bars.

5. An adjustable drum pedal in accordance with claim 1 wherein the drive assembly comprises:
a wheel device coupled to the frame;
a cord coupled to the wheel device and to the foot pedal; and
end caps coupled to a first end and a second end of the cord for securing the cord to the wheel device and the foot pedal.

6. An adjustable drum pedal in accordance with claim 5 wherein the wheel device has a channel, the cord resting in the channel, one of the end caps coupling the cord to the channel in the wheel device.

7. An adjustable drum pedal in accordance with claim 5 wherein the drive assembly further comprises a spring device coupled to the frame for bring back the drum beater mechanism to a starting position when pressure is removed from the foot pedal.

8. An adjustable drum pedal in accordance with claim 7 wherein the spring device further comprises:
end caps coupled to a first end and a second end of the spring device; and
a ring member coupled to each end cap to allow the spring device to rotate when the foot peddle is depressed and released.

9. An adjustable drum pedal comprising, in combination:
a foot pedal;
a base plate, wherein the base plate is shorter than the foot pedal;
a frame coupled to the base plate;
a support bar having a slot running a length of the support bar coupled to the frame and raised above the base plate;
a drum beater mechanism movably coupled to the frame to allow one to adjust a position of the drum beater mechanism on the frame;
a drive assembly movably coupled to the drum beater mechanism and the foot pedal for moving the drum beater mechanism when pressure is applied to the foot pedal and for returning the drum beater mechanism to a starting position when pressure is removed from the foot pedal;
a clamping device movably coupled to the base plate for allowing one to couple the adjustable drum pedal in multiple positions relative to a drum;
a foot pedal tab hingly coupled to the foot pedal for allowing the foot pedal to pivot in an up and down motion; and
a bar member having a first end coupled to the foot pedal tab and a second end slidably coupled in the slot in the support bar for adjusting a position of the foot pedal relative to the base plate.

10. An adjustable drum pedal in accordance with claim 9 further comprising:
a second slot running along a width of a top section of the base plate; and
a clamping device adjustment mechanism position in the second slot and coupled to the clamping device for allowing the clamping device to move within the second slot.

11. An adjustable drum pedal in accordance with claim 9 wherein the frame comprises:
a pair of support bars;
base members coupled to the base plate and the pair of support bars for coupling the support bars to the base plat; and
a cross bar rotatably coupled to the support bars.

12. An adjustable drum pedal in accordance with claim 9 wherein the drive assembly comprises:
a wheel device coupled to the frame;
a cord coupled to the wheel device and to the foot pedal; and
end caps coupled to a first end and a second end of the cord for securing the cord to the wheel device and the foot pedal.

13. An adjustable drum pedal in accordance with claim 12 wherein the wheel device has a channel, the cord resting in the channel, one of the end caps coupling the cord to the channel in the wheel device.

14. An adjustable drum pedal in accordance with claim 12 wherein the drive assembly further comprises a spring device coupled to the frame for bring back the drum beater mechanism to a starting position when pressure is removed from the foot pedal.

15. An adjustable drum pedal in accordance with claim 14 wherein the spring device further comprises:
end caps coupled to a first end and a second end of the spring device; and
a ring member coupled to each end cap to allow the spring device to rotate when the foot peddle is depressed and released.

16. An adjustable drum pedal comprising, in combination:
a foot pedal;
a base plate;
a frame coupled to the base plate;
a support bar having a slot running a length of the support bar coupled to the frame and raised above the base plate;
a drum beater mechanism movably coupled to the frame to allow one to adjust a position of the drum beater mechanism on the frame, wherein the drive assembly comprises:
a wheel device coupled to the frame;
a cord coupled to the wheel device and to the foot pedal; and
end caps coupled to a first end and a second end of the cord for securing the cord to the wheel device and the foot pedal;
a drive assembly movably coupled to the drum beater mechanism and the foot pedal for moving the drum beater mechanism when pressure is applied to the foot pedal and for returning the drum beater mechanism to a starting position when pressure is removed from the foot pedal;
a clamping device movably coupled to the base plate for allowing one to couple the adjustable drum pedal in multiple positions relative to a drum; and
a foot pedal tab hingly coupled to the foot pedal for allowing the foot pedal to pivot in an up and down motion; and
a bar member having a first end coupled to the foot pedal tab and a second end slidably coupled in the slot in the support bar for adjusting a position of the foot pedal relative to the base plate.

17. An adjustable drum pedal in accordance with claim 16 further comprising:
a second slot running along a width of a top section of the base plate; and
a clamping device adjustment mechanism position in the second slot and coupled to the clamping device for allowing the clamping device to move within the second slot.

18. An adjustable drum pedal in accordance with claim 16 wherein the wheel device has a channel, the cord resting in the channel, one of the end caps coupling the cord to the channel in the wheel device.

19. An adjustable drum pedal in accordance with claim 16 wherein the drive assembly further comprises a spring device coupled to the frame for bring back the drum beater mechanism to a starting position when pressure is removed from the foot pedal.

20. An adjustable drum pedal in accordance with claim 19 wherein the spring device further comprises:
end caps coupled to a first end and a second end of the spring device; and
a ring member coupled to each end cap to allow the spring device to rotate when the foot peddle is depressed and released.
